(19) United States
(12) Patent Application Publication
(10) Pub. No.: US 2013/0083962 A1
(43) Pub. Date: Apr. 4, 2013

(54) IMAGE PROCESSING APPARATUS

(71) Applicant: SANYO ELECTRIC CO., LTD., Osaka (JP)

(72) Inventors: Masayoshi Okamoto, Osaka (JP); Yoshiyuki Tsuda, Osaka (JP)

(73) Assignee: SANYO ELECTRIC CO., LTD., Osaka (JP)

(21) Appl. No.: 13/630,070

(22) Filed: Sep. 28, 2012

(30) Foreign Application Priority Data
Sep. 29, 2011 (JP) 2011-213780

(51) Int. Cl. G06K 9/62

(52) U.S. Cl. 382/103

(57) ABSTRACT

An image processing apparatus includes a definer. The definer defines a target image on a designated image. A first detector detects a degree of overlapping between the target image and a first specific object image appearing on the designated image. A second detector detects a degree of overlapping between the target image and a second specific object image appearing on the designated image. A modifier modifies the target image when the degree of overlapping detected by the first detector falls below a first reference or the degree of overlapping detected by the second detector is equal to or more than a second reference. A restrictor restricts a process of the modifier when the degree of overlapping detected by the first detector is equal to or more than the first reference and the degree of overlapping detected by the second detector falls below the second reference.

### CROSS REFERENCE OF RELATED APPLICATION

The disclosure of Japanese Patent Application No. 2011-213780, which was filed on Sep. 29, 2011, is incorporated herein by reference.

### BACKGROUND OF THE INVENTION

1. Field of the Invention

The present invention relates to an image processing apparatus, and more particularly, relates to an image processing apparatus which processes a target image defined on a designated image.

2. Description of the Related Art

According to this type of apparatus, a background removing device removes a background from a person image photographed by an image inputting device, based on a profile of the person. An image combining device combines the person image in which the background has been removed with a background image stored in a background image storing database so as to create an image in which a background is different.

However, in the above-described apparatus, it is not assumed that a target to be removed is variably set according to a user operation, and thus, there is a limit to a capability of processing an image.

### SUMMARY OF THE INVENTION

An image processing apparatus according to the present invention comprises: a definer which defines a target image on a designated image; a first detector which detects a degree of overlapping between the target image defined by the definer and a first specific object image appearing on the designated image; a second detector which detects a degree of overlapping between the target image defined by the definer and a second specific object image appearing on the designated image; a modifier which modifies the target image defined by the definer when the degree of overlapping detected by the first detector falls below a first reference or the degree of overlapping detected by the second detector is equal to or more than a second reference; and a restrictor which restricts a process of the modifier when the degree of overlapping detected by the first detector is equal to or more than the first reference and the degree of overlapping detected by the second detector falls below the second reference.

According to the present invention, an image processing program which is recorded on a non-temporary recording medium in order to control an image processing apparatus, wherein the program causes a processor of the image processing apparatus to execute: a defining step of defining a target image on a designated image; a first detecting step of detecting a degree of overlapping between the target image defined by the defining step and a first specific object image appearing on the designated image; a second detecting step of detecting a degree of overlapping between the target image defined by the defining step and a second specific object image appearing on the designated image; a modifying step of modifying the target image defined by the defining step when the degree of overlapping detected by the first detecting step falls below a first reference or the degree of overlapping detected by the second detecting step is equal to or more than a second reference; and a restricting step of restricting a process of the modifying step when the degree of overlapping detected by the first detecting step is equal to or more than the first reference and the degree of overlapping detected by the second detecting step falls below the second reference.

According to the present invention, an image processing method executed by an image processing apparatus, comprises: a defining step of defining a target image on a designated image; a first detecting step of detecting a degree of overlapping between the target image defined by the defining step and a first specific object image appearing on the designated image; a second detecting step of detecting a degree of overlapping between the target image defined by the defining step and a second specific object image appearing on the designated image; a modifying step of modifying the target image defined by the defining step when the degree of overlapping detected by the first detecting step falls below a first reference or the degree of overlapping detected by the second detecting step is equal to or more than a second reference; and a restricting step of restricting a process of the modifying step when the degree of overlapping detected by the first detecting step is equal to or more than the first reference and the degree of overlapping detected by the second detecting step falls below the second reference.

The above described characteristics and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of image data reproduced in the embodiment in FIG. 2;

FIG. 4 is an illustrative view showing another example of the image data reproduced in the embodiment in FIG. 2;

FIG. 5 is an illustrative view showing one example of an unnecessary object removing process in a collective removing mode;

FIG. 6 is an illustrative view showing another example of the unnecessary object removing process in the collective removing mode;

FIG. 7 is an illustrative view showing still another example of the unnecessary object removing process in the collective removing mode;

FIG. 8 is an illustrative view showing yet still another example of the unnecessary object removing process in the collective removing mode;

FIG. 9 is an illustrative view showing one example of the unnecessary object removing process in an individual removing mode;

FIG. 10 is an illustrative view showing another example of the unnecessary object removing process in the individual removing mode;

FIG. 11 is a flowchart showing one portion of an operation of a CPU applied to the embodiment in FIG. 2;

FIG. 12 is a flowchart showing another portion of the operation of the CPU applied to the embodiment in FIG. 2;

FIG. 13 is a flowchart showing still another portion of the operation of the CPU applied to the embodiment in FIG. 2;

FIG. 14 is a flowchart showing yet still another portion of the operation of the CPU applied to the embodiment in FIG. 2;

FIG. 15 is a flowchart showing another portion of the operation of the CPU applied to the embodiment in FIG. 2;

FIG. 16 is a flowchart showing still another portion of the operation of the CPU applied to the embodiment in FIG. 2; and

FIG. 17 is a block diagram showing a configuration of another embodiment of the present invention.

### DETAILED DESCRIPTION OF THE PREFERRED EMBODIMENTS

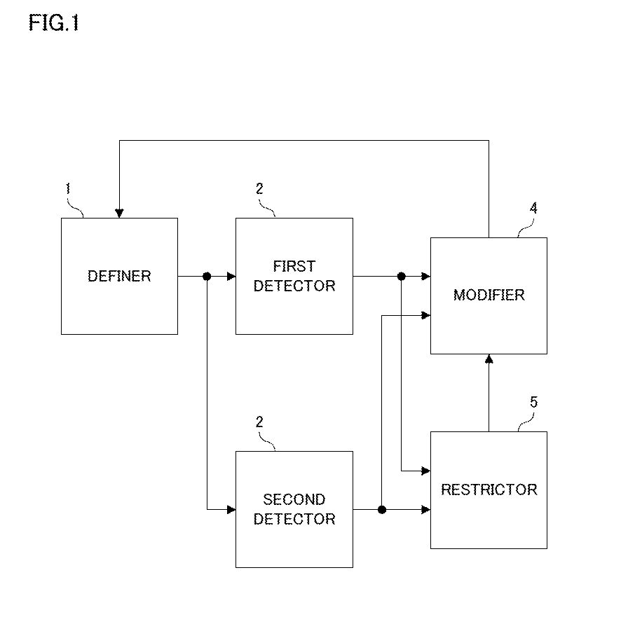

With reference to FIG. 1, an image processing apparatus of one embodiment of the present invention is basically configured as follows: A definer 1 defines a target image on a designated image. A first detector 2 detects a degree of overlapping between the target image defined by the definer 1 and a first specific object image appearing on the designated image. A second detector 3 detects a degree of overlapping between the target image defined by the definer 1 and a second specific object image appearing on the designated image. A modifier 4 modifies the target image defined by the definer 1 when the degree of overlapping detected by the first detector 2 falls below a first reference or the degree of overlapping detected by the second detector 3 is equal to or more than a second reference. A restrictor 5 restricts a process of the modifier 4 when the degree of overlapping detected by the first detector 2 is equal to or more than the first reference and the degree of overlapping detected by the second detector 3 falls below the second reference.

The process of modifying the target image is permitted when the degree of overlapping between the target image and the first specific object image is low or when the degree of overlapping between the target image and the second specific object image is high while the same process is restricted when the degree of overlapping between the target image and the first specific object image is high and when the degree of overlapping between the target image and the second specific object image is low. This serves to improve a capability of processing an image.

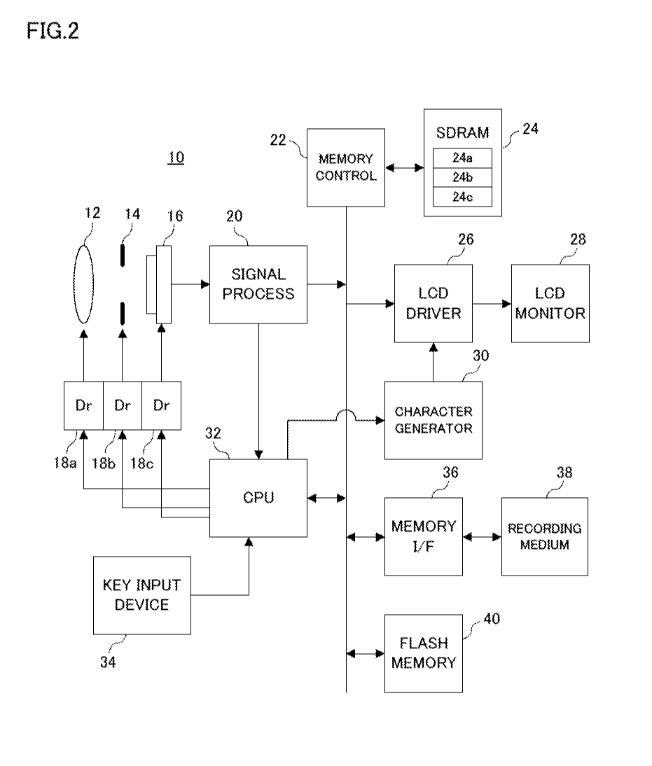

With reference to FIG. 2, a digital camera 10 according to this embodiment includes a focus lens 12 and an aperture unit 14 respectively driven by drivers 18a and 18b. An optical image that undergoes these members enters, with irradiation, an imaging surface of an imager 16, and is subjected to a photoelectric conversion.

When a camera mode is selected, a CPU 32 commands a driver 18c to repeat an exposure procedure and an electric-charge reading-out procedure in order to execute a moving-image taking process. In response to a vertical synchronization signal Vsync that is cyclically generated, the driver 18c exposes the imaging surface of the imager 16 and reads out electric charges produced on the imaging surface in a raster scanning manner. From the imager 16, raw image data based on the read-out electric charges is cyclically outputted.

A signal processing circuit 20 performs processes, such as white balance adjustment, color separation, and YUV conversion, on the raw image data outputted from the imager 16. The YUV-formatted image data produced thereby is written into a YUV image area 24a of an SDRAM 24 through a memory control circuit 22. An LCD driver 26 repeatedly reads out the image data accommodated in the YUV image area 24a through the memory control circuit 22, and drives an LCD monitor 28 based on the read-out image data. As a result, a real-time moving image (live view image) representing a scene captured on the imaging surface is displayed on a monitor screen.

Moreover, the signal processing circuit 20 applies Y data forming the image data to the CPU 32. The CPU 32 performs a simple AE process on the applied Y data so as to calculate an appropriate EV value, and sets an aperture amount and an exposure time which define the calculated appropriate EV value, to the drivers 18b and 18c, respectively. As a result, a brightness of the raw image data outputted from the imager 16 and that of the live view image displayed on the LCD monitor 28 are adjusted moderately.

When a recording operation is performed toward a key input device 34, the CPU 32 performs a strict AE process on the Y data applied from the signal processing circuit 20 so as to calculate an optimal EV value. Similarly to the above-described case, an aperture amount and an exposure time that define the calculated optimal EV value are set to the drivers 18b and 18c, respectively. Moreover, the CPU 32 performs an AF process on a high-frequency component of the Y data applied from the signal processing circuit 20. Thereby, the focus lens 12 is placed at a focal point.

Upon completion of the strict AF process, the CPU 32 executes a still image taking process, and at the same time, commands a memory I/F 36 to execute a recording process. The image data representing a scene at a time point at which the strict AF process is completed is evacuated by a still image taking process from the YUV image area 24a to a still image area 24b. The memory I/F 36 that is given a command to execute the recording process reads out the image data evacuated to the still image area 24b through the memory control circuit 22, and records an image file containing the read-out image data on a recording medium 38.

When a reproducing mode is selected, the CPU 32 designates a latest image file recorded on the recording medium 38, and commands the memory I/F 36 and the LCD driver 26 to execute a reproducing process in which the designated image file is noticed. The memory I/F 36 reads out the image data of the designated image file from the recording medium 38, and writes the read-out image data into the still image area 24b of the SDRAM 24 through the memory control circuit 22.

The LCD driver 26 reads out the image data accommodated in the still image area 24b through the memory control circuit 22, and drives the LCD monitor 28 based on the read-out image data. As a result, a reproduced image based on the image data of the designated image file is displayed on the LCD monitor 28. When a forward/rewind operation is performed toward the key input device 34, the CPU 32 designates a succeeding image file or a preceding image file. The designated image file is subjected to a reproducing process similar to that described above, and as a result, the reproduced image is updated.

When an unnecessary object removing operation is performed toward the key input device 34, the CPU 32 duplicates the image data developed in the still image area 24b into a work area 24c, and changes a display target to the image data duplicated in the work area 24c. The LCD driver 26 reads out the image data from the work area 24c, instead of the still image area 24b, and drives the LCD monitor 28 based on the read-out image data.

Subsequently, when a target region defining operation (operation for designating two coordinates on the monitor screen) is performed toward the key input device 34, the CPU 32 defines a rectangular region in which the designated two coordinates are opposite angles, as a target region, and executes the unnecessary object removing process (will be described in detail) while noticing the defined target region. The image data duplicated in the work area 24c is modified or processed so that an unnecessary object belonging to the target region is removed. The processed image is displayed on the LCD monitor 28.

Thereafter, when a recording operation is performed toward the key input device 34, the CPU 32 commands the memory I/F 36 to record the image data (modified or processed image data) accommodated in the work area 24c. The memory OF 36 reads out the image data accommodated in the work area 24c through the memory control circuit 22, and records the read-out image data on the recording medium 38 in a file format.

The unnecessary object removing process is executed as follows: Firstly, a face image is searched from the image data duplicated in the work area 24c. When the face image is sensed, a head portion image including the sensed face image is detected, and a region surrounded by a profile of the detected head portion image is defined as a head portion region. Furthermore, a body image including the detected head portion image is detected, and a region surrounded by a profile of the detected body image is defined as a body region.

Subsequently, a process menu display command is applied from the CPU 32 to a character generator 30. The character generator 30 applies character data that follows the command to the LCD driver 26, and the LCD driver 26 drives the LCD driver 28 based on the applied character data. As a result, a process menu is displayed on the monitor screen.

On the displayed process menu, two items such as a “collective removing mode” and an “individual removing mode” are listed. When the “collective removing mode” is selected by a menu operation, the collective removing process is executed. On the other hand, when the “individual removing mode” is selected by the menu operation, the individual removing process is executed.

In the collective removing process, firstly, an overlapping between the target region and each of the head portion region and the body region is detected, and it is determined whether or not the head portion region comes into contact with the target region (whether or not a degree of overlapping between the target region and the head portion region exceeds a first reference) and whether or not the target region is in a relationship encompassing the body region (whether or not a degree of overlapping between the target region and the body region exceeds a second reference).

When there is no contact between the target region and the head portion region, or when the target region encompasses the body region, the target region is set to a modified region. On the other hand, when the head portion region comes into contact with the target region, and one portion of the body region stays out of the target region, a region excluding the head portion region, out of the target region, is set to the modified region, under a condition that the head portion region is not covered with an obstacle. The image data on the work area 24c is modified so that an unnecessary object (unnecessary object: one or at least two cluster images having a common color) present in the modified region thus set is removed.

It is noted that when at least one portion of the head portion region is covered with the obstacle in a state where the head portion region comes into contact with the target region and one portion of the body region stays out of the target region, the modifying process as described above is prohibited, and instead thereof, notification is outputted for one second.

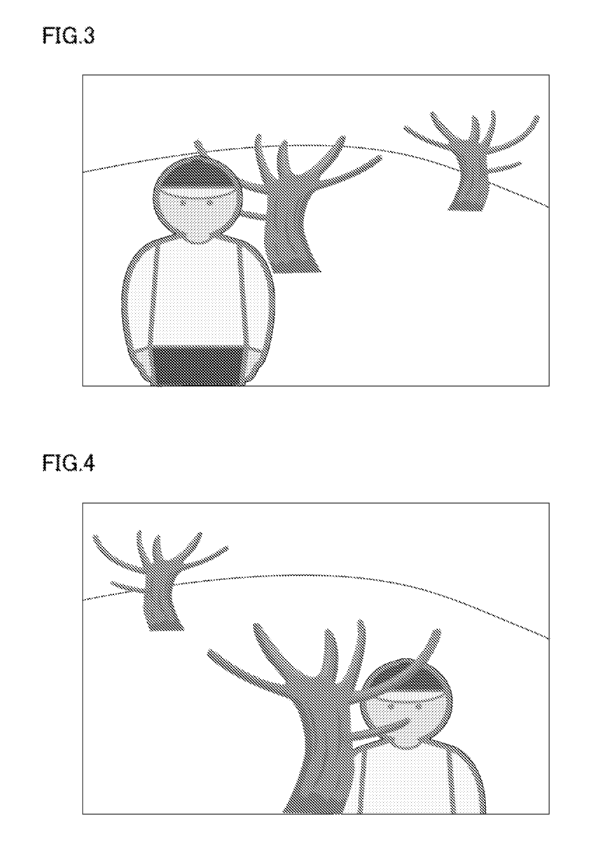

Therefore, when the target region is defined as shown at an upper level of FIG. 5 in a state where the image data shown in FIG. 3 is reproduced, there is no contact between the target region and the head portion region, and thus the target region is set to the modified region. As a result, the image data is modified so that a tree present in the target region is removed, and image data as shown at a lower level of FIG. 5 is obtained.

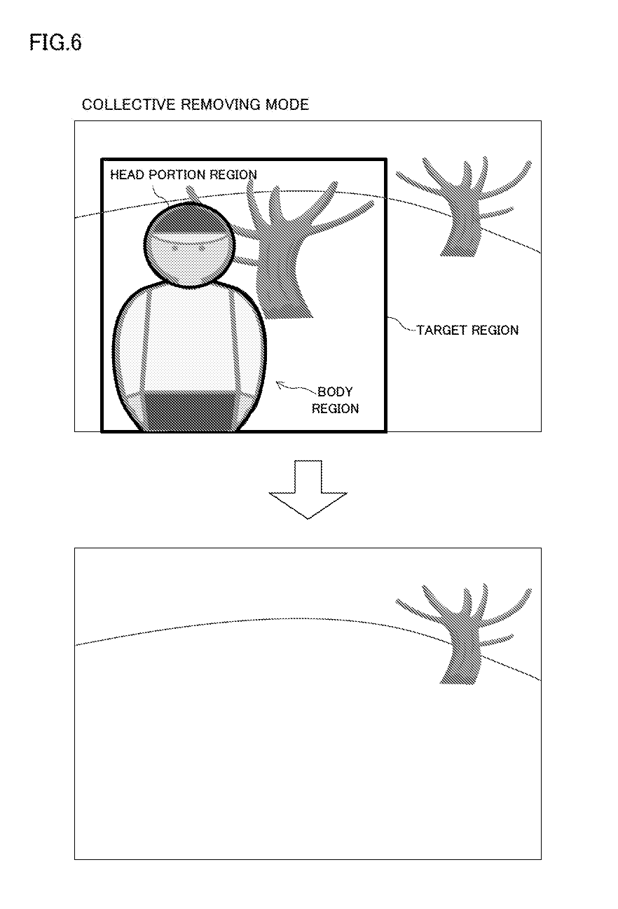

Moreover, when the target region is defined as shown at an upper level of FIG. 6 in a state where the image data shown in FIG. 3 is reproduced, the target region encompasses the body region, and thus, the target region is set to the modified region. As a result, the image data is modified so that a tree and a person present in the target region are removed, and image data shown at a lower level of FIG. 6 is obtained.

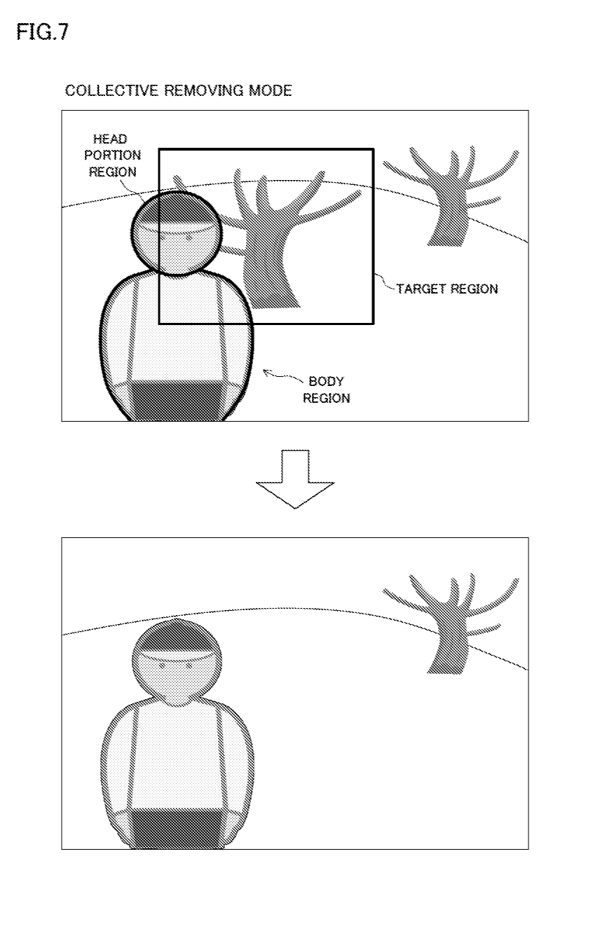

Furthermore, when the target region is defined as shown at an upper level of FIG. 7 in a state where the image data shown in FIG. 3 is reproduced, the head portion region comes into contact with the target region, one portion of the body region stays out of the target region, and the head portion region is not covered with the obstacle, and therefore, a region excluding the head portion region, out of the target region, is set to the modified region. As a result, the modifying process on the head portion region is limited, and the image data is modified so that a tree present in the target region is removed. The modified image data is obtained as shown at a lower level of FIG. 7.

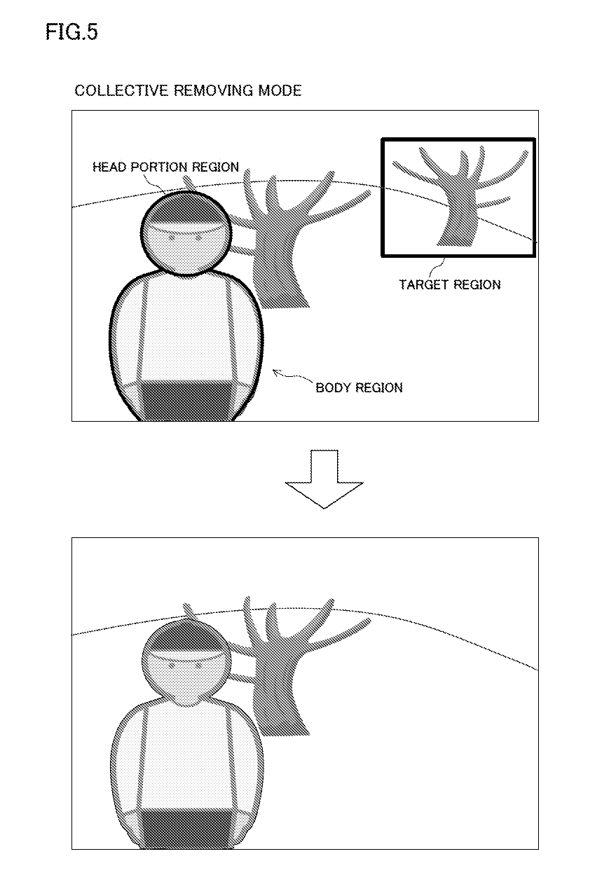

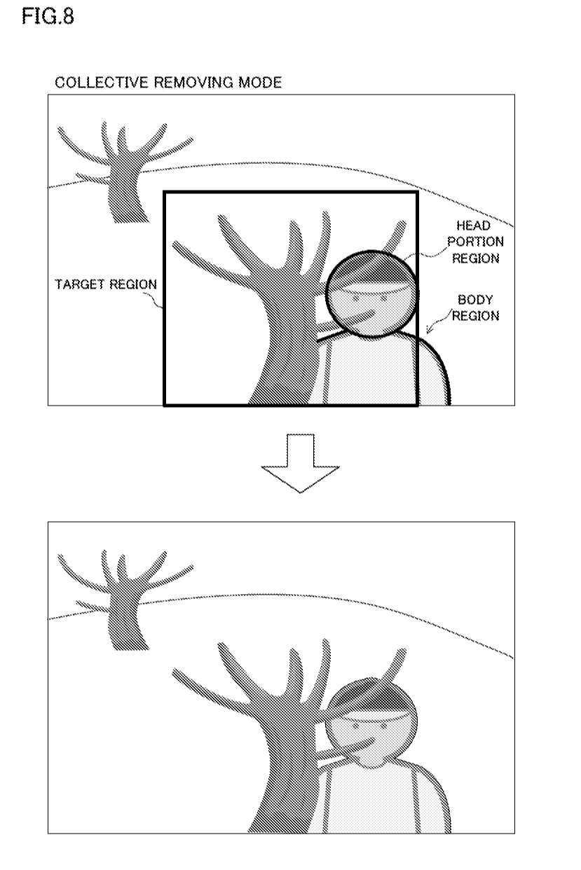

Moreover, when the target region is defined as shown at an upper level of FIG. 8 in a state where image data shown in FIG. 4 is reproduced, the head portion region comes into contact with the target region, one portion of the body region stays out of the target region, and the head portion region is covered with the obstacle, and therefore, the modifying process is prohibited. The image data maintains the initial state as shown at a lower level of FIG. 8.

In the individual removing process, firstly, one or at least two cluster images, each of which indicates a common color, are detected within the target region, and one or at least two partial regions respectively covering one or at least two detected cluster images are defined. It is noted that in detecting the cluster images, the body region is excluded from the detection target.

Subsequently, a variable K is set to each of “1” to “Kmax”, and an overlapping between the K-th partial region, and each of the head portion region and the body region is detected. Furthermore, it is determined whether or not the head portion region comes into contact with the K-th partial region (whether or not a degree of overlapping between the K-th partial region and the head portion region exceeds the first reference) and it is determined whether or not the K-th partial region is in a relationship to encompass the body region (whether or not a degree of overlapping between the K-th partial region and the body region exceeds the second reference). It is noted that “Kmax” is equivalent to a sum of the defined partial regions.

When there is no contact between the K-th partial region and the head portion region, or when the K-th partial region encompasses the body region, the K-th partial region is set to a modified region. Furthermore, when the head portion region comes into contact with the K-th partial region and one portion of the body region stays out of the K-th partial region, a region excluding the head portion region, out of the K-th partial region, is set to the modified region, under a condition that the head portion region is not covered with the obstacle. The image data on the work area 24c is modified so that an unnecessary object present in the modified region thus set is removed.

It is noted that, when at least one portion of the head portion region is covered with the obstacle in a state where the head portion region comes into contact with the K-th partial region and one portion of the body region stays out of the K-th partial region, the above-described modifying process on the K-th partial region is prohibited. Furthermore, when there is no setting of the modified region, notification is outputted for one second.

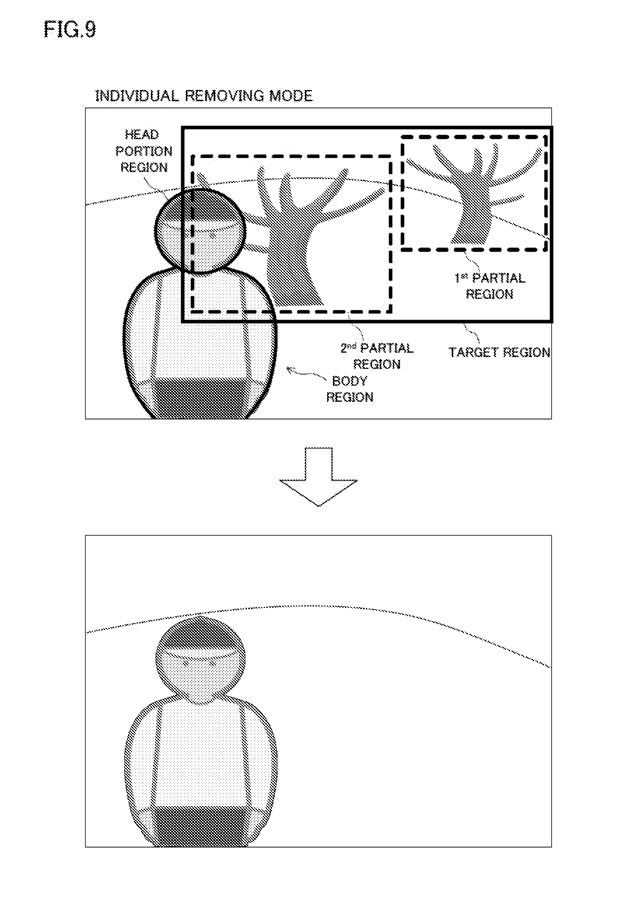

Therefore, when the target region is defined as shown at an upper level of FIG. 9 in a state where the image data shown in FIG. 3 is reproduced, two partial regions respectively covering two trees are set. There is no contact between the first partial region, out of the set two partial regions, and the head portion region, and thus, the first partial region is set to the modified region. On the other hand, the second partial region comes into contact with the head portion region, one portion of the body region stays out of the second partial region, and the head portion region is not covered with the obstacle, and therefore, a region excluding the head portion region, out of the second partial region, is set to the modified region. As a result, the image data is modified so that two trees respectively belonging to the two partial regions, are removed, and image data shown at a lower level of FIG. 9 is obtained.

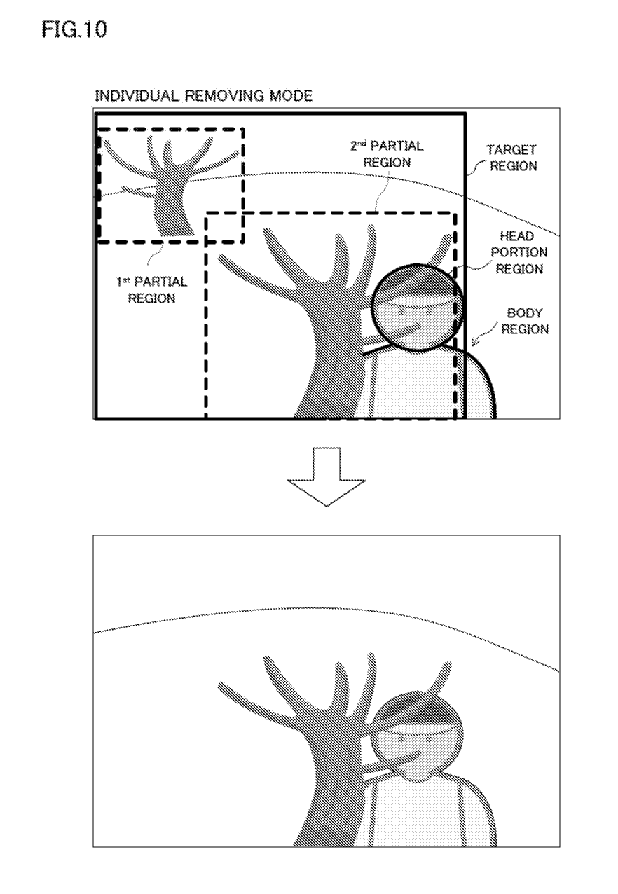

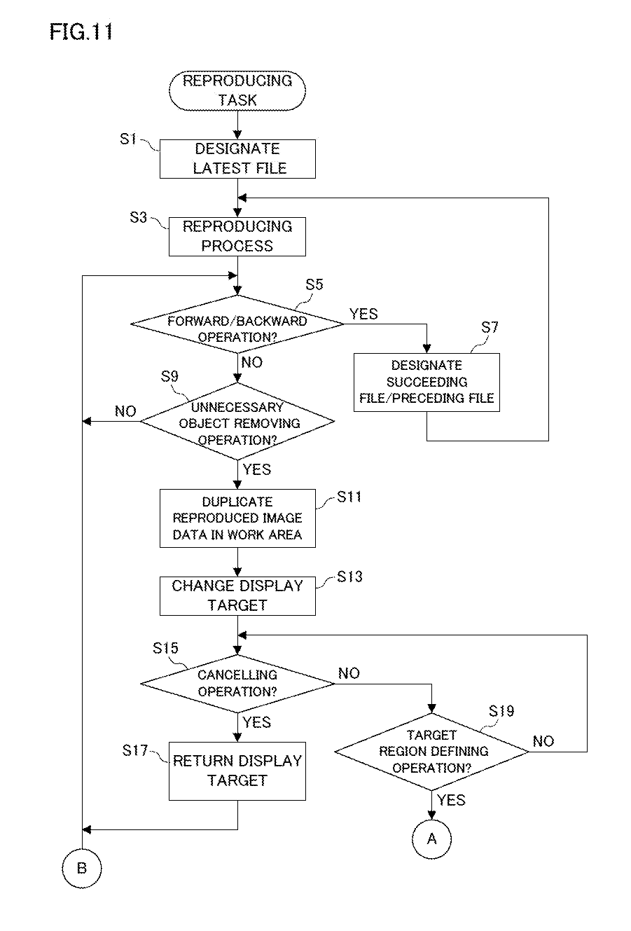

Moreover, when the target region is defined as shown at an upper level of FIG. 10 in a state where the image data shown in FIG. 4 is reproduced, two partial regions respectively covering two trees are set. There is no contact between the first partial region, out of the set two partial regions, and the head portion region, and thus, the first partial region is set to the modified region. On the other hand, the second partial region comes into contact with the head portion region, one portion of the body region stays out of the second partial region, and the head portion region is covered with the obstacle, the setting of the modified region to the second partial region is prohibited. As a result, the image data is processed so that a tree belonging to the first partial region is removed, and image data shown at a lower level of FIG. 10 is obtained.

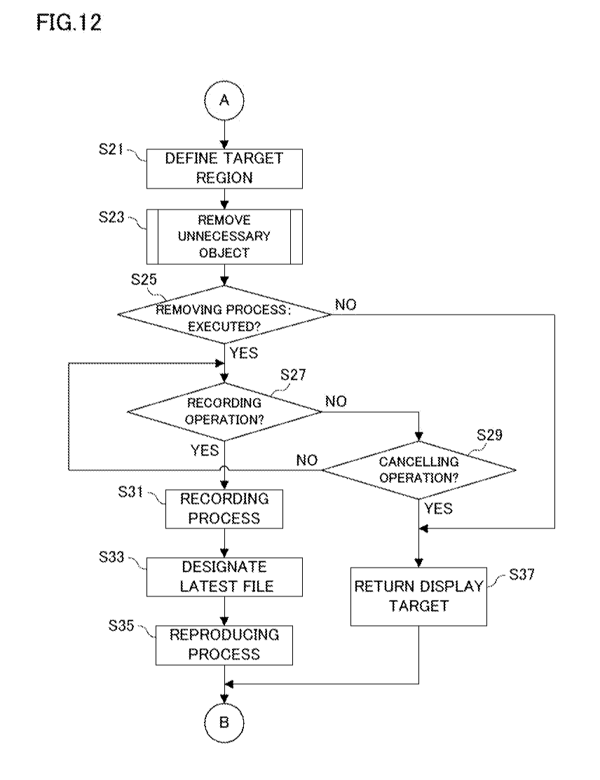

The CPU 32 executes a reproducing task shown in FIG. 11 to FIG. 16 when a reproducing mode is selected. It is noted that the CPU 32 is a CPU which executes a plurality of tasks in parallel on a multi-task OS such as μITRON. Furthermore, a control program corresponding to the tasks executed by the CPU 32 is stored in a flash memory 40.

With reference to FIG. 11, in a step S1, a latest image file recorded on the recording medium 38 is designated, and in a step S3, the memory I/F 36 and the LCD driver 26 are given a command to perform the reproducing process in which the designated image file is noticed.

The memory I/F 36 reads out the image data contained in the designated image file from the recording medium 38, and writes the read-out image data into the still image area 24b of the SDRAM 24 through the memory control circuit 22. The LCD driver 26 reads out the image data accommodated in the still image area 24b through the memory control circuit 22, and drives the LCD monitor 28 based on the read-out image data. As a result, the reproduced image is displayed on the LCD monitor 28.

In a step 55, it is determined whether or not the forward/rewind operation is performed, and in a step S9, it is determined whether or not the unnecessary object removing operation is performed. When a determination result of the step 55 is YES, the process proceeds to a step S7 so as to designate a succeeding image file or a preceding image file recorded on the recording medium 38. Upon completion of the designating process, the process returns to the step S3. As a result, another reproduced image is displayed on the LCD monitor 28.

When a determination result of the step S9 is YES, the process proceeds to a step S11 so as to duplicate the image data developed in the still image area 24b in the work area 24c. In a step S13, the display target is changed to the image data duplicated in the work area 24c.

In a step S15, it is determined whether or not a cancelling operation is performed, and in a step S19, it is determined whether or not a target region defining operation is performed. When a determination result of the step S15 is YES, the display target is returned to the image data from which it is duplicated (image data developed in the still image area 24b) in a step S17, and then, the process returns to the step S5.

When a determination result of the step S19 is YES, the process proceeds to a step S21 so as to define the target region according to the target region defining operation. In a step S23, the unnecessary object removing process is executed while noticing the defined target region. In a step S25, it is determined whether or not an unnecessary object is removed by the process of the step S23 (whether or not the image data is modified). When a determination result is NO, the display target is returned to the image data from which it is duplicated in a step S37, and then, the process returns to the step S5. When the determination result is YES, whether or not the recording operation is performed is determined in a step S27, and whether or not the cancelling operation is performed is determined in a step S29.

When a determination result of the step S27 is YES, the process proceeds to a step S31 so as to command the memory I/F 36 to record the image data (modified image data) accommodated in the work area 24c. The memory I/F 36 reads out the image data accommodated in the work area 24c through the memory control circuit 22, and records the read-out image data on the recording medium 38 in a file format. Upon completion of the recording process, processes similar to those in the steps S1 to S3 are executed in steps S33 to S35, and then, the process returns to the step S5. On the other hand, when the determination result of the step S29 is YES, the process returns to the step S5 after undergoing the step S37.

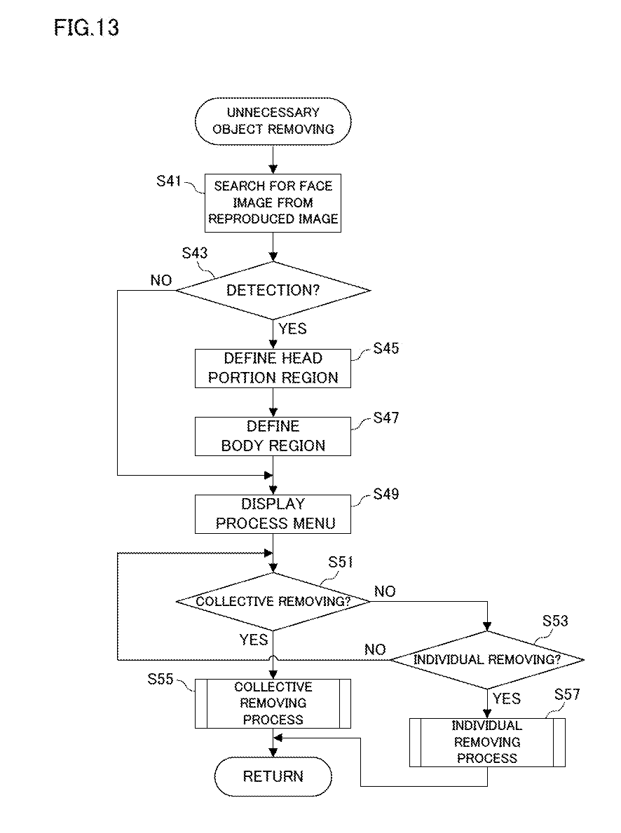

The unnecessary object removing process in the step S23 is executed according to subroutines shown in FIG. 13 to FIG. 16. In a step S41, the face image is searched from the image data duplicated in the work area 24c. In a step S43, it is determined whether or not the face image is sensed by the searching process, and when a determination result is NO, the process directly proceeds to a step S49 while when the determination result is YES, the process proceeds to the step S49 after undergoing processes in steps S45 to S47. In the step S45, the head portion image including the sensed face image is detected, and a region surrounded by a profile of the detected head portion image is defined as the head portion region. In the step S47, the body image including the head portion image detected in the step S45 is detected, and a region surrounded by a profile of the detected body image is defined as the body region.

In the step S49, the process menu display command is applied to the character generator 30. The character generator 30 applies the character data according to the command, to the LCD driver 26, and the LCD driver 26 drives the LCD monitor 28 based on the applied character data. As a result, a process menu is displayed on the monitor screen. On the displayed process menu, two items such as a “collective removing mode” and an “individual removing mode” are listed.

In a step S51, it is determined whether or not the “collective removing mode” is selected by the menu operation, and in a step S53, it is determined whether or not the “individual removing mode” is selected by the menu operation. When a determination result of the step S51 is YES, the collective removing process is executed in a step S55, and when a determination result of the step S53 is YES, the individual removing process is executed in a step S57. Upon completion of the process in the step S55 or S57, the process is returned to a routine at an upper hierarchical level.

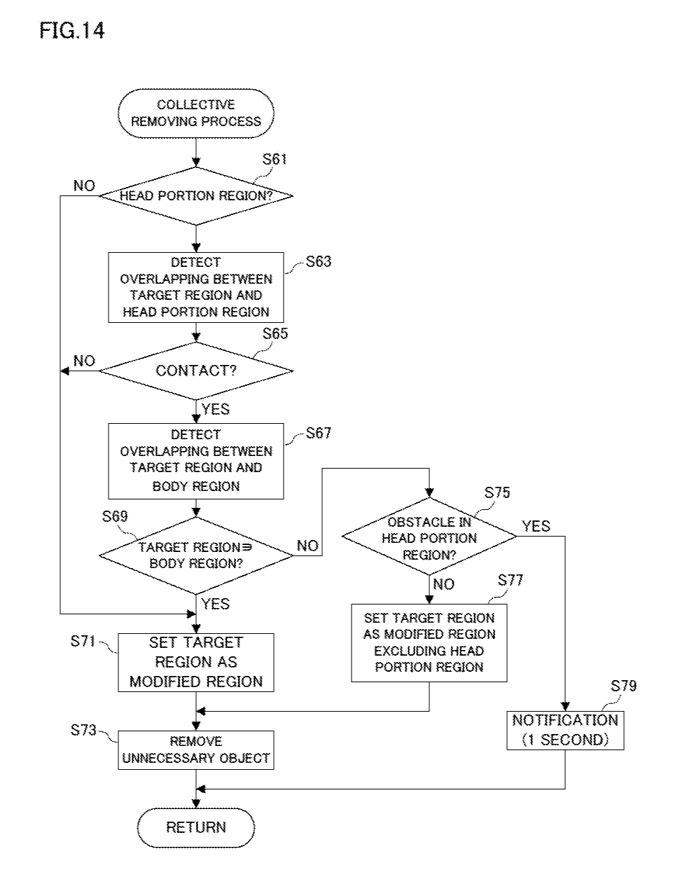

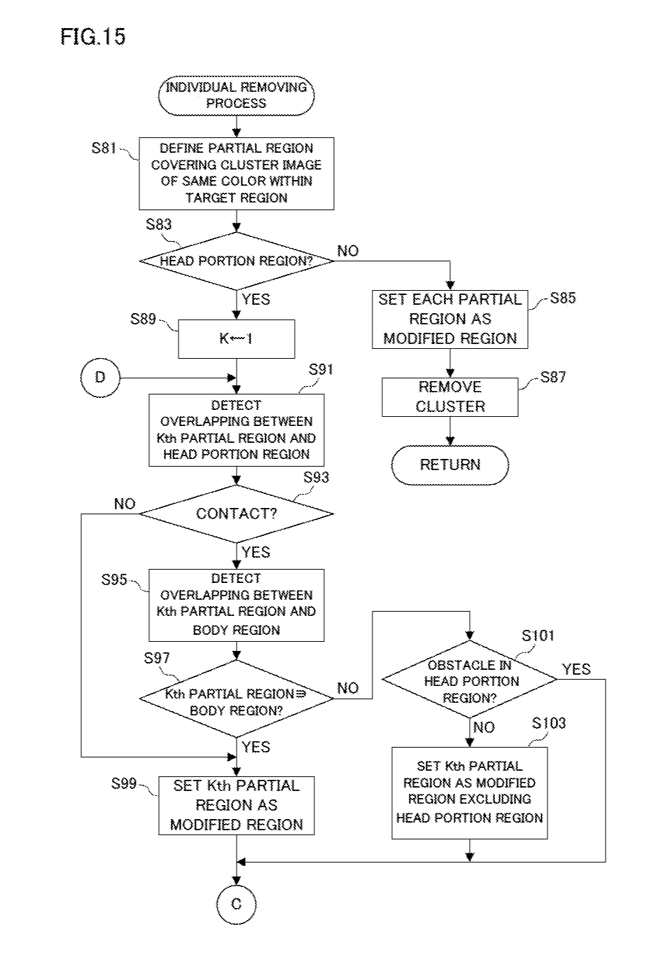

The collective removing process in the step S55 is executed according to a subroutine shown in FIG. 14. Firstly, in a step S61, it is determined whether or not the head portion region is defined, and when a determination result is YES, the overlapping between the target region and the head portion region is detected in a step S63. In a step S65, whether or not the head portion region comes into contact with the target region (whether or not the degree of overlapping between the target region and the head portion region exceeds the first reference) is determined based on detection result of the step S63, and when a determination result is YES, the overlapping between the target region and the body region is detected in a step S67.

In a step S69, whether or not the target region is in a relationship to encompass the body region (whether or not the degree of overlapping between the target region and the body region exceeds the second reference) is determined based on a detection result of the step S67. When a determination result is YES, the process proceeds to a step S71, and when the determination result is NO, the process proceeds to a step S75. It is noted that when the determination result of the step S61 is NO or when the determination result of the step S65 is NO, the process directly proceeds to the step S71.

In the step S71, the target region is set to the modified region, and in a step S73, the image data on the work area 24c is modified so that the unnecessary object present in the modified region is removed. In the step S75, it is determined whether or not at least one portion of the head portion region is covered with the obstacle. When a determination result is NO, a region excluding the head portion region, out of the target region, is set to the modified region in a step S77. Upon completion of the setting, the process proceeds to the step S73. When a determination result of the step S75 is YES, a notification is outputted for one second in a step S79. Upon completion of the process in the step S73 or S79, the process returns to a routine at an upper hierarchical level.

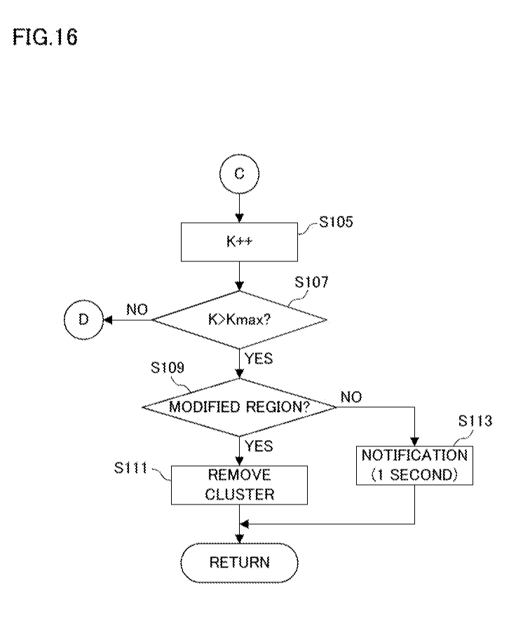

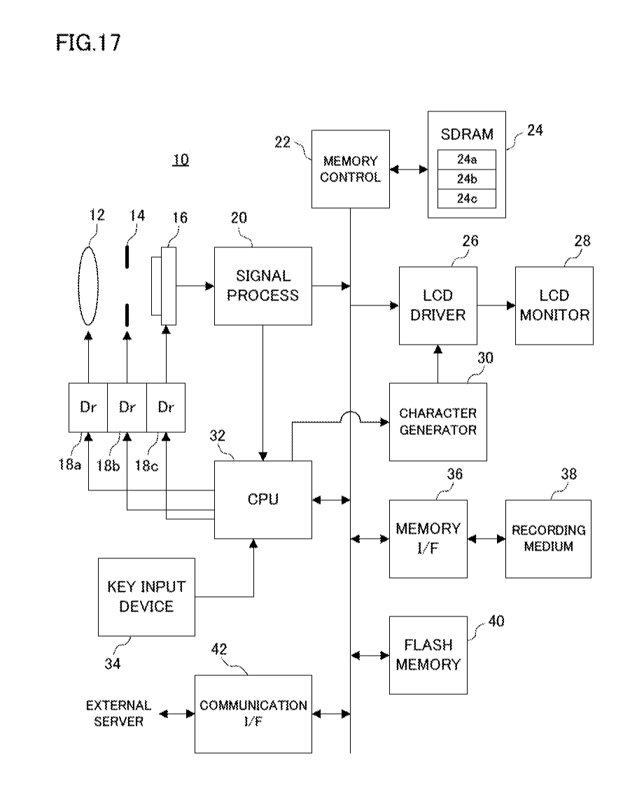

The individual removing process of the step S57 shown in FIG. 13 is executed according to a subroutine shown in FIG. 15 and FIG. 16. In a step S81, one or at least two cluster images, each of which indicates a common color, are detected within the target region, and one or at least two partial regions respectively covering the detected one or at least two cluster images are defined. It is noted that in the process of the step S81, the body region is excluded from the detection target.

In a step S83, it is determined whether or not the head portion region is defined, and when a determination result is YES, the process proceeds to a step S89 while when the determination result is NO, the process proceeds to a step S85. In the step S85, each of the partial regions defined in the step S81 is set to the modified region. In a step S87, the image data on the work area 24c is modified so that the cluster images present in the set modified region are removed. When all the cluster images are removed, the process returns to a routine at a hierarchical upper level.

In the step S89, the variable K is set to “1”, and in a step S91, the overlapping between the K-th partial region and the head portion region is detected. In a step S93, whether or not the head portion region comes into contact with the K-th partial region (whether or not the degree of overlapping between the K-th partial region and the head portion region exceeds the first reference) is determined based on a determination result of the step S91, and when the determination result is YES, the overlapping between the K-th partial region and the body region is detected in a step S95.

In a step S97, whether or not the K-th partial region is in a relationship to encompass the body region (whether or not the degree of overlapping between the K-th partial region and the body region exceeds the second reference) is determined based on a detection result of the step S95. When a determination result is YES, the process proceeds to a step S99, and when the determination result is NO, the process proceeds to a step S101. It is noted that when the determination result of the step S93 is NO, the process directly proceeds to the step S99.

In the step S99, the K-th partial region is set to the modified region, and then, the process proceeds to a step S105. In the step S101, it is determined whether or not at least one portion of the head portion region is covered with the obstacle. When a determination result is YES, the process directly proceeds to the step S105, and when the determination result is NO, the process proceeds to the step S105 after undergoing the process of a step S103. In the step S103, a region excluding the head portion region, out of the K-th partial region, is set to the modified region.

In the step S105, the variable K is incremented, and in a step S107, it is determined whether or not the variable K exceeds a maxim value Kmax (=sum of the partial regions). When a determination result is NO, the process returns to the step S91, and when the determination result is YES, the process proceeds to a step S109. In the step S109, it is determined whether or not at least one modified region is set, and when a determination result is YES, the process proceeds to a step S111 while when the determination result is NO, the process proceeds to a step S113.

In the step S111, the image data on the work area 24c is modified so that the cluster images present in the processed region are removed. In contrast, in the step S113, notification is outputted for one second. Upon completion of the process in the step S111 or S113, the process returns to a routine at an upper hierarchical level.

As understood from the above description, when the target region defining operation is performed by the key input device 34, the CPU 32 defines the target region on the reproduced image data (S19 to S21), and the region in which the head portion image of the person appears and the region in which the body image of the person appears are defined as the head portion region and the body region (S45 to S47). When the collective removing mode is selected, the CPU 32 detects the degree of overlapping between the target region, and each of the head portion region and the body region (S63, S67). When the individual removing mode is selected, the CPU 32 defines one or at least two partial regions respectively covering one or at least two cluster images appearing in the target region (S81), and detects the degree of overlapping between each partial region, and each of the head portion region and the body region (S91, S95). The modifying process on the target region or each partial region is permitted when the degree of overlapping with the head portion region falls below the first reference or when the degree of overlapping with the body region is equal to or more than the second reference (S71 to S73, S99, and S111), and is restricted when the degree of overlapping with the head portion region is equal to or more than the first reference and when the degree of overlapping with the body region falls below the second reference (S75 to S77 and S101 to S103).

Herein, the first reference is equivalent to the degree of overlapping at which at least one portion of the head portion region comes into contact with the target region or the partial region, and the second reference is equivalent to the degree of overlapping in which the body region is encompassed by the target region or the partial region.

Thus, the modifying process on the target image is permitted when the degree of overlapping with the head portion region is low or when the degree of overlapping with the body region is high, while is restricted when the degree of overlapping with the head portion region is high and the degree of overlapping with the body region is low. This serves to improve a capability of modifying an image.

It is noted that in this embodiment, when the head portion region comes into contact with the target region or the partial region and one portion of the body region stays out of the target region or the partial region, the modified region is set while excluding the head portion region (see FIG. 7 and FIG. 9). However, the modified region may be set with excluding both the head portion region and the body region.

Furthermore, in this embodiment, when the head portion region is defined, the profile of the head portion image is strictly detected. However, an ellipsoidal region surrounding the head portion image may be defined as the head portion region.

Moreover, in this embodiment, the degree of overlapping at which at least one portion of the head portion region comes into contact with the target region or the partial region is set to the first reference, and the degree of overlapping at which the body region is encompassed by the target region or the partial region is set to the second reference. However, a degree of overlapping at which 10% (=one example of a value exceeding 0%) of the head portion region comes into contact with the target region or the partial region may be set to the first reference, and a degree of overlapping at which 80% (=one example of a value falling below 100%) of the body region comes into contact with the target region or the partial region may be set to the second reference.

Moreover, as long as a characteristic portion such as an eye, a nose, and a mouth stays out of the target region or the partial region, even when one portion of the head portion region comes into contact with the target region or the partial region, one portion of the contacted head portion region may be included in the modified region.

Furthermore, in this embodiment, a shape of the target region is limited to a rectangle. However, if a touch panel and a touch pen are prepared and a region designated by an operation of the touch panel is defined as the target region, then the shape of the target region may be in a variety of forms.

Furthermore, in this embodiment, as the head portion image and the body image, the images representing a head portion and a body of a person are assumed. However, images representing a head portion and a body of an animal may be assumed as the head portion image and the body image.

Furthermore, in this embodiment, the multi-task OS and the control program equivalent to the plurality of tasks executed by the same are stored in advance on the flash memory 40. However, as shown in FIG. 17, a communication I/F 42 is provided in the digital camera 10, and one portion of a control program is prepared, as an internal control program, from a start in the flash memory 40 while another portion of the control program may be acquired, as an external control program, from an external server. In this case, the above-described operations are implemented by the cooperation of the internal control program and the external control program.

Moreover, in this embodiment, the process executed by the CPU 32 is categorized into a plurality of tasks as shown above. However, each of the tasks may be further divided into a plurality of smaller tasks, and furthermore, one portion of the plurality of the divided smaller tasks may be integrated with other tasks. Also, in a case of dividing each of the tasks into a plurality of smaller tasks, all or one portion of these may be obtained from an external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
a definer which defines a target image on a designated image;
a first detector which detects a degree of overlapping between the target image defined by said definer and a first specific object image appearing on the designated image;
a second detector which detects a degree of overlapping between the target image defined by said definer and a second specific object image appearing on the designated image;
a modifier which modifies the target image defined by said definer when the degree of overlapping detected by said first detector falls below a first reference or the degree of overlapping detected by said second detector is equal to or more than a second reference; and
a restrictor which restricts a process of said modifier when the degree of overlapping detected by said first detector is equal to or more than the first reference and the degree of overlapping detected by said second detector falls below the second reference.

2. An image processing apparatus according to claim 1, wherein said restrictor includes an excluder which excludes the first specific object image noticed by said first detector from a processing target of said modifier.

3. An image processing apparatus according to claim 1, wherein said restrictor includes a prohibiter which prohibits a process of said modifier when there is an obstacle image covering at least one portion of the first specific object image noticed by said first detector.

4. An image processing apparatus according to claim 1, wherein said definer includes an acceptor which accepts a region setting operation on the designated image, a cluster image detector which detects one or at least two cluster images, each of which belongs to the region set by the region setting operation and has a common color, and a partial image designator which designates, as the target image, each of one or at least two partial images respectively covering one or at least two cluster images detected by said cluster image detector.

5. An image processing apparatus according to claim 1, wherein the second reference is equivalent to a degree of overlapping at which the second specific object image is encompassed by the target image.

6. An image processing apparatus according to claim 1, wherein each of the first specific object image and the second specific object image is equivalent to an image representing at least one portion of a common object, and the second specific object image is equivalent to one portion of the first specific object image.

7. An image processing apparatus according to claim 1, wherein the first specific object image and the second specific object image are equivalent to a head portion image and a body image, respectively.

8. An image processing program which is recorded on a non-temporary recording medium in order to control an image processing apparatus, wherein the program causes a processor of the image processing apparatus to execute:
a defining step of defining a target image on a designated image;
a first detecting step of detecting a degree of overlapping between the target image defined by said defining step and a first specific object image appearing on the designated image;
a second detecting step of detecting a degree of overlapping between the target image defined by said defining step and a second specific object image appearing on the designated image;
a modifying step of modifying the target image defined by said defining step when the degree of overlapping detected by said first detecting step falls below a first reference or the degree of overlapping detected by said second detecting step is equal to or more than a second reference; and
a restricting step of restricting a process of said modifying step when the degree of overlapping detected by said first detecting step is equal to or more than the first reference and the degree of overlapping detected by said second detecting step falls below the second reference.

9. An image processing method executed by an image processing apparatus, comprising:
a defining step of defining a target image on a designated image;
a first detecting step of detecting a degree of overlapping between the target image defined by said defining step and a first specific object image appearing on the designated image;
a second detecting step of detecting a degree of overlapping between the target image defined by said defining step and a second specific object image appearing on the designated image;
a modifying step of modifying the target image defined by said defining step when the degree of overlapping detected by said first detecting step falls below a first reference or the degree of overlapping detected by said second detecting step is equal to or more than a second reference; and
a restricting step of restricting a process of said modifying step when the degree of overlapping detected by said first detecting step is equal to or more than the first reference and the degree of overlapping detected by said second detecting step falls below the second reference.
